(19) United States
(12) Patent Application Publication
(10) Pub. No.: US 2023/0394877 A1
(43) Pub. Date: Dec. 7, 2023

(54) System and Method for Infant Facial Estimation

(71) Applicant: Northeastern University, Boston, MA (US)

(72) Inventors: Sarah OSTADABBAS, Watertown, MA (US); Emily ZIMMERMAN, Boston, MA (US); Xiaofei HUANG, Lynnfield, MA (US); Michael WAN, Brunswick, ME (US)

(21) Appl. No.: 18/205,226

(22) Filed: Jun. 2, 2023

Related U.S. Application Data
(60) Provisional application No. 63/349,018, filed on Jun. 3, 2022.

(51) Int. Cl. G06V 40/16; G06V 10/82; G06V 10/774; G06V 20/70

(52) U.S. Cl. CPC G06V 40/172; G06V 10/82; G06V 40/171; G06V 10/774; G06V 20/70

(57) ABSTRACT

Provided herein are methods and systems for identifying a face of an infant in an image including providing a computer comprising a processor and a memory trained with a set of training images and programmed with a convolutional neural network (CNN) model for identifying a face of an infant in a test image suspected of comprising an infant's face, wherein each image of the set of training images includes a plurality of facial landmark annotations and at least one pose attribute annotation, providing a test image suspected of comprising an image of an infant's face, and processing the test image using the computer, whereby the infant's face is identified in the test image.

### CROSS REFERENCE TO RELATED APPLICATIONS

This application claims benefit under 35 U.S.C. § 119(e) of U.S. Provisional Application No. 63/349,018, filed on 3 Jun. 2022, entitled “SYSTEM AND METHOD FOR INFANT FACIAL ESTIMATION,” the entirety of which is incorporated by reference herein.

### BACKGROUND

Facial landmark estimation has a long history, with many pioneering models based on fitting face meshes or face models recently surpassed by pure convolutional neural network (CNN) regression methods. However, while vision-based methods have met with some success on adult faces, hardly any analogous models exist in the domain of infant faces. Part of the problem is that infants rarely appear in human images “in the wild,” and, when they do, facial landmark estimation is made difficult because infant faces are often small and obscured and hence less useful for the purposes of facial landmark estimation.

While in principle, face model methods could help with the wide array of poses inherent in the infant domain, only one attempt to build such a model for infants has been made. (See Araceli Morales, Antonio R. Porras, Liyun Tu, Marius George Lingu-raru, Gemma Piella, and Federico M. Sukno, “Spectral Correspondence Framework for Building a 3D Baby Face Model,” in 2020 15th IEEE International Conference on Automatic Face and Gesture Recognition (FG 2020), Buenos Aires, Argentina, Nov. 2020, pp. 708-715, IEEE.), which relies on 3D scans and is not available for public use.

By contrast, there are several adult datasets of faces “in the wild,” used to train and benchmark facial landmark estimation models. For example, datasets featuring 68 facial landmarks adhering to the Multi-PIE layout include the Helen dataset of 2000 training and 300 test images, the Annotated Faces in the Wild (AFW) dataset of 205 images, featuring large variation in head poses and multiple faces per image, and various well-known datasets stemming from the 300 Faces In-the-Wild Challenge (300-W). Infant faces are hardly represented at all, accounting for only 1.4% of the diverse AFW dataset. There is a need for improved methods for facial landmark estimation as applied to infants.

### SUMMARY

Systems and methods for infant facial estimation are provided herein which use facial landmark estimation models trained with a dataset comprising a plurality of infant annotated faces. Such systems and methods facilitate the computerized comprehension of infant faces and can be used in applications from healthcare to psychology, especially in the early prediction of developmental disorders. The systems and methods provided herein introduce a new annotated infant facial imaging dataset including both facial landmark annotations and pose attribute annotations. In addition, the systems and methods provided herein introduce new models trained using domain adaptation techniques and the present newly introduced annotated infant facial imaging dataset. In some instances, that training includes joint training of the model by training rotation between the new annotated infant facial imaging dataset and a second set of training images. In some instances, the joint training can also include training rotation between two or more untrained models.

In one aspect, a method for identifying a face of an infant in an image is provided. The method includes providing a computer comprising a processor and a memory trained with a set of training images and programmed with a convolutional neural network (CNN) model for identifying a face of an infant in a test image suspected of comprising an infant's face, wherein each image of the set of training images includes a plurality of facial landmark annotations and at least one pose attribute annotation. The method also includes providing a test image suspected of comprising an image of an infant's face. The method also includes processing the test image using the computer, whereby the infant's face is identified in the test image.

In some embodiments, the plurality of facial landmarks include at least interocular distance and minimal containment box. In some embodiments, the plurality of facial landmark annotations adhere to a Multi-PIE layout. In some embodiments, the at least one pose annotation includes a binary annotation indicating at least one of whether infant's face is turned, tilted, occluded, or excessively expressive. In some embodiments, the step of processing the image further comprises identifying one or more of the plurality of facial landmarks of the identified infant's face in the test image. In some embodiments, a series of test images are processed, the series of test images obtained from a video recording of an infant. In some embodiments, the one or more facial landmarks are identified in each image of the series of test images, and wherein the one or more facial landmarks are tracked from image to image. In some embodiments, the method is used in at least one of a method of identifying a behavior, identifying a developmental stage, diagnosing a developmental abnormality, or diagnosing a medical condition of an infant depicted in the test image. In some embodiments, the behavior is non-nutritive sucking behavior. In some embodiments, the method is used to identify an individual infant depicted in the test image. In some embodiments, the method also includes jointly training the memory by rotating training between the set of training images and a second set of training images. In some embodiments, the method also includes jointly training the memory by rotating training between the CNN model for identifying a face of an infant and a second CNN model for identifying a face of an infant. In some embodiments, the CNN model includes at least one of HRNet, HRNetV2-W18, HRNet-R90JT, HRNet-R90FT, HRNet-R150GJT, 3FabRec, RetinaFace, or combinations thereof.

In another aspect, a method of producing a set of training images for training a convolutional neural network (CNN) model to identify a face of an infant in a test image is provided. The method includes providing a set of facial images of a plurality of different human infants. The method also includes annotating each image of the set to define a plurality of facial landmarks. The method also includes annotating each image of the set with at least one facial pose attribute.

In some embodiments, the plurality of facial landmarks include at least interocular distance and minimal containment box. In some embodiments, the plurality of facial landmark annotations adhere to a Multi-PIE layout. In some embodiments, the at least one pose annotation includes a binary annotation indicating at least one of whether infant's face is turned, tilted, occluded, or excessively expressive. In some embodiments, the step of annotating each image of the set with at least one facial pose attribute also includes applying a binary annotation indicating the infant's face is turned if at least one of the eyes, nose, and mouth are not clearly visible. In some embodiments, the step of annotating each image of the set with at least one facial pose attribute also includes applying a binary annotation indicating the infant's face is tilted if the head axis, projected on the image plane, is 45° or more beyond upright. In some embodiments, the step of annotating each image of the set with at least one facial pose attribute also includes applying a binary annotation indicating the infant's face is occluded if landmarks are covered by body parts or objects. In some embodiments, the step of annotating each image of the set with at least one facial pose attribute also includes applying a binary annotation indicating the infant's face is excessively expressive if the facial muscles are tense due to an exaggerated facial expression.

In yet another aspect, a system for identifying a face of an infant in an image is provided. The system includes a computer. The computer includes a processor. The computer also includes a memory trained with a set of training images and programmed with a convolutional neural network (CNN) model for identifying a face of an infant in a test image suspected of comprising an infant's face, wherein the set of training images is obtained by a method. The method includes providing a set of facial images of a plurality of different human infants. The method also includes annotating each image of the set to define a plurality of facial landmarks. The method also includes annotating each image of the set with at least one facial pose attribute.

In some embodiments, the system also includes an imaging system in electronic communication with the computer, the imaging system configured to capture a series of test images of an infant and to provide the series of test images to the computer.

Additional features and aspects of the technology include the following:
1. A method for identifying a face of an infant in an image, the method comprising the steps of:
   providing a computer comprising a processor and a memory trained with a set of training images and programmed with a convolutional neural network (CNN) model for identifying a face of an infant in a test image suspected of comprising an infant's face, wherein each image of the set of training images includes a plurality of facial landmark annotations and at least one pose attribute annotation;
   providing a test image suspected of comprising an image of an infant's face; and
   processing the test image using the computer, whereby the infant's face is identified in the test image.
2. The method of feature 1, wherein the plurality of facial landmarks include at least interocular distance and minimal containment box.
3. The method of any of features 1-2, wherein the plurality of facial landmark annotations adhere to a Multi-PIE layout.
4. The method of any of features 1-3, wherein the at least one pose annotation includes a binary annotation indicating at least one of whether infant's face is turned, tilted, occluded, or excessively expressive.
5. The method of any of features 1-4, wherein the step of processing the image further comprises identifying one or more of the plurality of facial landmarks of the identified infant's face in the test image.
6. The method of feature 5, wherein a series of test images are processed, the series of test images obtained from a video recording of an infant.
7. The method of feature 6, wherein the one or more facial landmarks are identified in each image of the series of test images, and wherein the one or more facial landmarks are tracked from image to image.
8. The method of any of features 1-7, wherein the method is used in at least one of a method of identifying a behavior, identifying a developmental stage, diagnosing a developmental abnormality, or diagnosing a medical condition of an infant depicted in the test image.
9. The method of feature 8, wherein the behavior is non-nutritive sucking behavior.
10. The method of any of features 1-9, wherein the method is used to identify an individual infant depicted in the test image.
11. The method of any of features 1-10, further comprising jointly training the memory by rotating training between the set of training images and a second set of training images.
12. The method of any of features 1-11, further comprising jointly training the memory by rotating training between the CNN model for identifying a face of an infant and a second CNN model for identifying a face of an infant.
13. The method of any of features 1-12, wherein the CNN model includes at least one of HRNet, HRNetV2-W18, HRNet-R90JT, HRNet-R90FT, HRNet-R150GJT, 3FabRec, RetinaFace, or combinations thereof
14. A method of producing a set of training images for training a convolutional neural network (CNN) model to identify a face of an infant in a test image, the method comprising the steps of:
   providing a set of facial images of a plurality of different human infants; and
   annotating each image of the set to define a plurality of facial landmarks; and
   annotating each image of the set with at least one facial pose attribute.
15. The method of feature 14, wherein the plurality of facial landmarks include at least interocular distance and minimal containment box.
16. The method of any of features 14-15, wherein the plurality of facial landmark annotations adhere to a Multi-PIE layout.
17. The method of any of features 14-16, wherein the at least one pose annotation includes a binary annotation indicating at least one of whether infant's face is turned, tilted, occluded, or excessively expressive.
18. The method of feature 17, wherein the step of annotating each image of the set with at least one facial pose attribute further comprises at least one of:
   applying a binary annotation indicating the infant's face is turned if at least one of the eyes, nose, and mouth are not clearly visible;
   applying a binary annotation indicating the infant's face is tilted if the head axis, projected on the image plane, is 45° or more beyond upright;
   applying a binary annotation indicating the infant's face is occluded if landmarks are covered by body parts or objects; or
   applying a binary annotation indicating the infant's face is excessively expressive if the facial muscles are tense due to an exaggerated facial expression.
19. A system for identifying a face of an infant in an image, the system comprising a computer comprising:
   a processor; and
   a memory trained with a set of training images and programmed with a convolutional neural network (CNN) model for identifying a face of an infant in a test image suspected of comprising an infant's face, wherein the set of training images is obtained by the method of any of features 14-18.
20. The system of feature 19, further comprising an imaging system in electronic communication with the computer, the imaging system configured to capture a series of test images of an infant and to provide the series of test images to the computer.

### BRIEF DESCRIPTION OF THE DRAWINGS

FIG. 1 illustrates images from a dataset of infant annotated faces (InfAnFace) and ground truth facial landmarks, grouped by annotated attributes.

FIG. 2 illustrates model predictions on InfAnFace Test images, from 3FabRec, HRNet, and a new model described herein, HRNet-R90JT. Landmark predictions with low error are indicated within each image as white marks, landmark predictions with high error are indicated within each image as dark marks.

FIG. 3 illustrates cumulative normalized mean error (NME) curves for HRNet and 3FabRec facial landmark estimation models, highlighting the performance gap between infants (InfAnFace) and adults (300-W). Errors under both the interocular (iod) and minimal bounding box (box) normalization factors are shown.

FIG. 4 illustrates a t-SNE visualization of the internal HRNet representations of adult 300-W and InfAnFace images, highlighting the domain gap between them. InfAnFace Common is more closely integrated with the adult images compared to the more divergent InfAnFace Challenging. Together they comprise InfAnFace Test, which has roughly the same distribution as InfAnFace Train.

FIG. 5 illustrates a structure of high-resolution net (HRNet), the backbone for the new models disclosed herein, featuring parallel multi-resolution convolutional layers.

FIG. 6 illustrates a visualization depicting the performance per landmark of HRNet against new model HRNet-R90JT across various InfAnFace subset, with each landmark radius drawn in proportion to the subset-mean interocular-normalized error for that landmark. (Landmark positions are as in FIG. 7.)

FIG. 7 illustrates mean ground truth landmarks across various adult 300-W and InfAnFace image sets, scaled to a common width. Infant faces appear squatter.

FIG. 8 illustrates cumulative normalized mean error (NME) curves showing the significant improvement realized by the new HRNet-R90JT model (dashed lines) over HRNet (solid lines), across various InfAnFace Test subsets. The performance gains are especially notable on the InfAnFace Challenging set. Performance of HRNet on an adult 300-W Test set is included for comparison.

### DETAILED DESCRIPTION

Provided herein are methods and systems for infant facial estimation using facial landmark estimation models trained with a dataset comprising a plurality of infant annotated faces. Such systems and methods facilitate the computerized comprehension of infant faces via facial landmark estimation. Infant facial estimation is of significant interest due to a potential for opening up new avenues of research in healthcare and cognitive psychology. For instance, links between early infant motor or oral function and subsequent developmental disruptions—such as autism spectrum disorder, cerebral palsy, and pediatric feeding disorders—inspire a tantalizing vision of computerized screening or even discovery of prodromal (or pre-symptomatic) risk markers, grounded on automatic facial landmark estimation.

As described herein, in order to train facial landmark estimation models for infant facial estimation, a novel dataset including infant faces annotated with facial landmark coordinates and pose attributes was generated (InfAnFace). In addition, to overcome the inadequacies of existing facial landmark estimation models in the infant domain, new state-of-the-art models using domain adaptation techniques were trained by the InfAnFace dataset, significantly improving upon those existing models. The technology is also related to the task of facial detection for infants. Accordingly, the present disclosure also provides a case study of infrared baby monitor images useful to assess developmental issues.

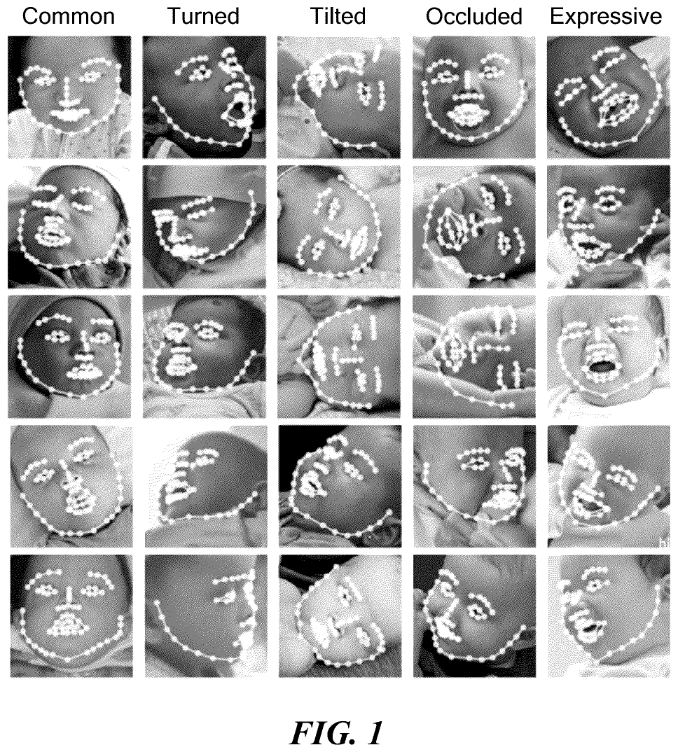

In some embodiments, a dataset of infant annotated faces (InfAnFace) includes 410 images of infant faces with labels for 68 facial landmark locations and various pose attributes as shown in FIG. 1. The technology also organizes InfAnFace into a “Train” set, intended for machine learning, and an independently sourced “Test” set, intended to serve as a field benchmark.

In general, the present technology uses convolutional neural-network (CNN) regression models because they are more flexible and more powerful than conventional techniques. In particular, the well-established high-resolution network (HRNet) model (See Jingdong Wang, Ke Sun, Tianheng Cheng, Borui Jiang, Chaorui Deng, Yang Zhao, Dong Liu, Yadong Mu, Mingkui Tan, Xinggang Wang, Wenyu Liu, and Bin Xiao, “Deep High-Resolution Representation Learning for Visual Recognition,” IEEE Transactions on Pattern Analysis and Machine Intelligence, vol. 43, no. 10, pp. 3349-3364, Oct. 2021.), which uses multi-resolution CNN blocks to carry high-fidelity representations throughout the entire network, was tested and modified. The 3FabRec model (See Bjorn Browatzki and Christian Wallraven, “3FabRec: Fast Few-Shot Face Alignment by Reconstruction,” in 2020 IEEE/CVF Conference on Computer Vision and Pattern Recognition (CVPR), Seattle, WA, USA, June 2020, pp. 6109-6119, IEEE.) was also tested and was found to achieve few-shot facial landmark localization via unsupervised autoencoder pre-training.

Face detection, a prerequisite for facial landmark estimation, is another mature field, generally executed via CNN methods. To assess the present technology in the context of face detection, a state-of-the-art RetinaFace model (See Jiankang Deng, Jia Guo, Yuxiang Zhou, Jinke Yu, Irene Kotsia, and Stefanos Zafeiriou, “Retinaface: Single-stage dense face localisation in the wild,” CoRR, vol. abs/1905.00641, 2019.) was also trained using the InfAnFace dataset.

The Infant Annotated Faces Dataset (InfAnFace)

To establish a dataset of infant annotated faces (InfAnFace), a total of 410 images were sourced and annotated with 68 facial landmarks plus pose attributes, by a team of researchers, to encourage variety and independence. Infants are only featured in a small fraction of human photographs, and when they do appear, their faces are often small or obscured, so gathering a sizable set of images useful for facial landmark estimation models with deep structures is non-trivial. Facial annotations are also more difficult for infants because features are less well-defined, poses are more varied, and natural obstructions like pacifiers are more prevalent. Thus, these diverse sets of well-annotated images represent a completely new training dataset specifically created to improve and advance infant facial estimation, a field of study which is itself in its infancy. The results, as described below, demonstrate the effectiveness of InfAnFace for machine learning training and testing.

Landmark Annotations

The 68 facial landmark annotations used in connection with the InfAnFace dataset adhere to the industry standard Multi-PIE layout. Coordinates were included for the minimal bounding box, the smallest upright box containing all of the landmarks. Following industry conventions for 2D-based annotations, landmarks obscured by the face itself (e.g., when turned) were assigned to the nearest point on the face which is visible in the image, as the true projected position is hard to estimate. A standard annotation tool was applied, as well as the specialized human—artificial intelligence hybrid tool AH-CoLT, with the landmark predictions of the FAN model serving as the starting point for the human annotations.

Although the datasets described herein and tested in connection with the CNN models described herein each include 68 facial landmark annotations in an industry-standard Multi-PIE layout for 2D images, it will be apparent in view of this disclosure that images used to establish a dataset of infant annotated faces can be 2D or 3D and can be annotated, in some embodiments, using any landmark annotation scheme having any number of landmarks. For example, landmark annotation schemes can use 2 or more landmarks, 4 to 50,000 landmarks, or 8 to 33,000 landmarks, including, for example, landmark schemes including any of 8, 34, 49, 68, 80, 1,000, 15,000, 30,000, 33,000, or more landmarks. It will be further apparent in view of this disclosure that any of the CNN models described herein can be trained and used in connection with any dataset of infant annotated faces, whether 2D or 3D, annotated using any landmark annotation scheme having any number of landmarks as described above.

Face Attributes

To facilitate analysis, binary annotations were included for each image, indicating whether infant's face is: turned (if the eyes, nose, and mouth are not clearly visible), tilted (if the head axis, projected on the image plane, is 45° or more beyond upright), occluded (if landmarks are covered by body parts or objects), and excessively expressive (if the facial muscles are tense due to an exaggerated facial expression such as when crying, laughing, pouting, frowning, etc.).

Sourcing and the Test—Train Split

InfAnFace images were sourced from Google Images and YouTube via a wide range of search queries to obtain a diversity of appearances, poses, expressions, scene conditions, and image quality. Approximately two-fifths of the infants represented appear to be non-white. For machine learning experiments, InfAnFace was split into dedicated training and test sets, with the following composition: InfAnFace Train, including 210 images, with 51- and 55-image batches drawn respectively from Google and YouTube, and a 105-image batch drawn from a specialized search on YouTube for infant formula advertisements; and InfAnFace Test, including 200 images, with two 100-image batches drawn respectively from Google and YouTube. These five “batches” were sourced and annotated by rotating configurations of researchers, ensuring a level of variety and independence between them and hence between InfAnFace Train and InfAnFace Test as well.

Attributes and the Common—Challenging Split

The break-down of annotated attributes across InfAnFace and its Train and Test subsets, shown in Table I, demonstrates that all three sets exhibit a healthy diversity of ideal and adverse conditions. Each attribute is present in each set to a large enough degree to be useful for training or analysis, but the distributional differences between InfAnFace Train and Test also highlight their independence. To aid interpretability of experiments performed on InfAnFace Test, the images were partitioned further into two subsets based on the annotated attributes: InfAnFace Common, the subset 80 images with faces free from all adverse attributes; and InfAnFace Challenging, the remaining set of 120 images exhibiting at least one of them.

TABLE I
ATTRIBUTE INCIDENCE RATES IN INFANFACE SUBSETS

| Attribute | % of Inf. Train | % of Inf. Test | % of InfAnFace |
|---|---|---|---|
| Turned | 28.6 | 12.5 | 20.2 |
| Tilted | 28.6 | 36.5 | 32.0 |
| Occluded | 26.2 | 14.0 | 20.2 |
| Expressive | 37.1 | 14.5 | 26.1 |

To sum up, InfAnFace (410 images) was split into InfAnFace Train (210) and InfAnFace Test (200), and InfAnFace Test into InfAnFace Common (80) and InfAnFace Challenging (120).

Illustration of the Infant-Adult Domain Gap

The facial landmark domain gap between infants and adults was examined by comparing InfAnFace Test with three predominantly adult image sets: 300-W Test (600 images), 300-W Common (554 images), and 300-W Challenging (135 images). The definitions for InfAnFace Test, Common, and Challenging loosely track with these 300-W sets, with Common featuring relatively easy poses, InfAnFace Test a balanced mix of poses, and InfAnFace Challenging the most difficult poses. The 300-W images are partially taken from earlier datasets so a range of sources is represented. The analysis started with a brief comparison of geometric attributes, and then turned to a study of facial landmark estimation model performance on InfAnFace vs. 300-W, before capping off the section with a visualization of one of the model's internal representations of each image.

Geometric Observations

Some geometric measures of interest across various adult and infant subsets are recorded in Table II. The first column shows that the aspect ratios of the minimal bounding boxes for mean adult faces are ˜1:1, compared to ˜5:4 for infants. The second column of Table II records the mean ratios of two commonly used normalization factors in facial landmark estimation. These normalization factors and the significance of these values are discussed in the next section.

TABLE II
Geometric values across adult 300-W and InfAnFace images

| Image Set | $\frac{μ ( min . box width )}{μ ( min . box height )}$ | $μ ( \frac{min . box size}{interocular dist .} )$ |
|---|---|---|
| 300-W Test | 1.01 | 1.69 |
| 300-W Common | 1.03 | 1.67 |
| 300-W Challenging | 1.02 | 1.85 |
| InfAnFace Test | 1.28 | 1.53 |
| InfAnFace Common | 1.28 | 1.48 |
| InfAnFace Challenging | 1.27 | 1.56 |

Benchmarking Facial Landmark Estimation

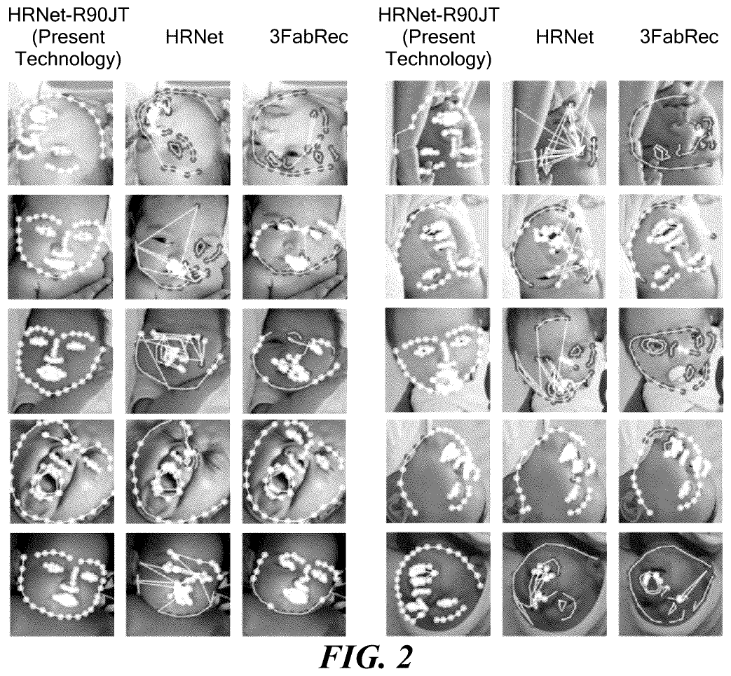

In order the demonstrate the gap in facial landmark estimation between adults and infants, and to establish baseline performance metrics, predictions were performed using two recent 2D facial landmarking models, HRNet (with the pretrained HRNetV2-W18 model) and 3FabRec (with the pretrained 300-W model). A selection of predicted landmarks is shown in FIG. 2, which also includes improved predictions from a new model, HRNet-R90JT, described in greater detail below.

The main error metric for facial landmark estimation is the normalized mean error (NME): the mean Euclidean distance between each predicted landmark and the corresponding ground truth landmark, divided by a normalization factor with the same units (pixels), to achieve scale-independence. Two normalization factors were considered: the interocular distance (iod), defined as the distance between the two outer corners of the eyes, and the minimal bounding box size (box), defined as the geometric mean of its height and width. The means of the ratios of these two normalization factors across various infant and adult sets is recorded in the second column of Table II. Those values show that the gap between metric performance on adults and infants will be greater on average under the box norm, compared to the interocular norm. Neither error metric is likely to be domain invariant, so using both provides a more rounded comparison. Note that although NME is sometimes reported as a percentage, it can exceed 100 in value.

The mean NMEs are tabulated under both normalizations and for both models' landmark predictions across various adult and infant image sets in Table III. Further characterizations of landmark estimation performance include the failure rate (FR) of images in the dataset with NME greater than a set threshold, and the area under the curve (AUC) of the cumulative NME distribution up to a set threshold.

TABLE III
LANDMARK ESTIMATION NORMALIZED MEAN ERROR (NME,
↓ IS BETTER) UNDER iod AND box NORMALIZATIONS,
ON ADULT 300-W AND INFANFACE IMAGES

| | 300-W Test | | 300-W Comm. | | 300-W Chal. | |
|---|---|---|---|---|---|---|
| Model | iod ↓ | box ↓ | iod ↓ | box ↓ | iod ↓ | box ↓ |
| 3FabRec (CVPR ′20) | 3.85 | 2.24 | 3.40 | 2.04 | 5.74 | 3.10 |
| HRNet (TPAMI ′21) | 3.85 | 2.28 | 2.92 | 1.76 | 5.13 | 2.77 |

| | InfAnFace Test | | InfAnFace Comm. | | InfAnFace Chal. | |
|---|---|---|---|---|---|---|
| Model | iod ↓ | box ↓ | iod ↓ | box ↓ | iod ↓ | box ↓ |
| 3FabRec (CVPR ′20) | 12.59 | 8.13 | 4.93 | 3.36 | 17.69 | 11.31 |
| 3FabRec-JT | 9.28 | 6.04 | 4.90 | 3.34 | 12.20 | 7.84 |
| 3FabRec-FT | 9.00 | 5.86 | 5.30 | 3.59 | 11.47 | 7.37 |
| 3FabRec-R90 | 8.45 | 5.52 | 5.45 | 3.71 | 10.45 | 6.73 |
| 3FabRec-R90JT | 8.00 | 5.22 | 5.12 | 3.49 | 9.93 | 6.39 |
| HRNet (TPAMI ′21) | 12.82 | 8.35 | 5.07 | 3.45 | 17.98 | 11.62 |
| HRNet-JT | 5.95 | 3.87 | 4.47 | 3.03 | 6.94 | 4.43 |
| HRNet-FT | 5.90 | 3.85 | 4.48 | 3.04 | 6.84 | 4.38 |
| HRNet-R90 | 5.90 | 3.87 | 4.88 | 3.31 | 6.58 | 4.24 |
| HRNet-R90JT (ours) | 5.30 | 3.47 | 4.52 | 3.07 | 5.82 | 3.73 |
| HRNet-R90FT (ours) | 5.40 | 3.52 | 4.68 | 3.17 | 5.88 | 3.78 |

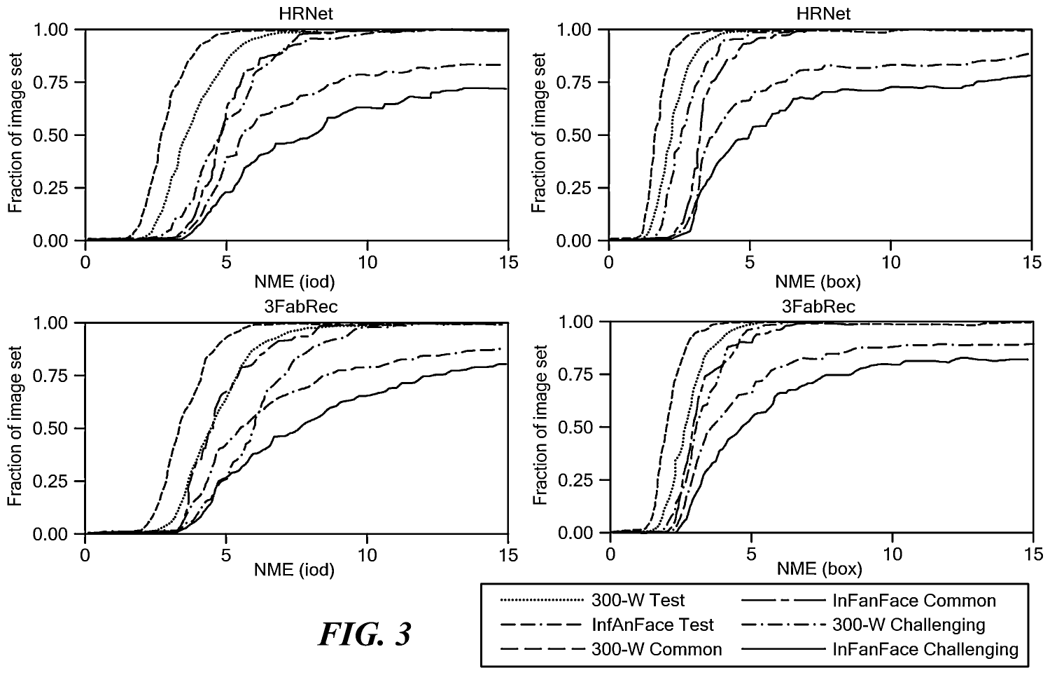

Table IV reports the FR and AUC for NME normalized by the interocular distance, with a threshold of NME=10. (Both tables also include results from the present improved models) FIG. 3 plots the cumulative NME distribution curves themselves, under both normalizations, and with a threshold of NME=15 for greater context.

TABLE IV
LANDMARK ESTIMATION FAILURE RATE (FR, OUT OF 100, ↓
IS BETTER) AND AREA UNDER THE CURVE (AUC, OUT OF 100, ↑ IS
BETTER) AT NME_{iod} = 10, ON ADULT 300-W AND INFANFACE IMAGES

| | 300-W Test | | 300-W Comm. | | 300-W Chal. | |
|---|---|---|---|---|---|---|
| Model | FR ↓ | AUC ↑ | FR ↓ | AUC ↑ | FR ↓ | AUC ↑ |
| 3FabRec (CVPR ′20) | 1.17 | 52.72 | 0.00 | 64.73 | 2.22 | 38.95 |
| HRNet (TPAMI ′21) | 0.33 | 61.54 | 0.18 | 70.83 | 2.22 | 48.84 |

| | InfAnFace Test | | InfAnFace Comm. | | InfAnFace Chal. | |
|---|---|---|---|---|---|---|
| Model | FR ↓ | AUC ↑ | FR ↓ | AUC ↑ | FR ↓ | AUC ↑ |
| 3FabRec (CVPR ′20) | 21.00 | 36.66 | 0.00 | 51.69 | 35.00 | 26.63 |
| 3FabRec-JT | 17.00 | 37.34 | 1.25 | 51.38 | 27.50 | 27.98 |
| 3FabRec-FT | 14.50 | 35.29 | 0.00 | 46.88 | 24.17 | 27.57 |
| 3FabRec-R90 | 18.00 | 33.21 | 1.25 | 46.15 | 29.17 | 24.58 |
| 3FabRec-R90JT | 14.00 | 36.16 | 1.25 | 49.43 | 22.50 | 27.32 |
| HRNet (TPAMI ′21) | 22.50 | 34.75 | 0.00 | 49.30 | 37.50 | 25.06 |
| HRNet-JT | 7.00 | 45.52 | 0.00 | 55.32 | 11.67 | 38.99 |
| HRNet-FT | 6.00 | 45.91 | 0.00 | 53.22 | 10.00 | 39.71 |
| HRNet-R90 | 5.00 | 43.75 | 0.00 | 51.18 | 8.33 | 38.80 |
| HRNet-R90JT (ours) | 2.50 | 48.07 | 0.00 | 54.69 | 4.17 | 43.65 |
| HRNet-R90FT (ours) | 3.00 | 46.87 | 0.00 | 53.23 | 5.00 | 42.63 |

These results show a significant performance gap between adult and infant domains as a whole, which, in line with expectations from Table II, is more pronounced under the box norm. Within each domain, performance degrades from the Common to Test to Challenging sets. Furthermore, poor performance on InfAnFace Test seems largely attributable to the difficulty of the InfAnFace Challenging subset. These considerations, as well as a visual inspection of landmark predictions as in FIG. 2, expose adverse conditions defining the InfAnFace Challenging subset, such as tilt and occlusion, as likely causes of poor facial landmark estimations on infant faces. Such conditions are believed to be endemic to infant images captured in the wild, and thus, infant-focused models should seek to overcome them.

While the performance results on InfAnFace Challenging are the most dramatic, the tables and graphs also reveal a smaller but definite performance gap between results on InfAnFace Common and the adult image sets, particularly the 300-W Common and 300-W Test sets, which arguably serve as fairer points of comparison. This suggests that even in more ideal pose conditions, a domain gap exists.

t-SNE Visualization

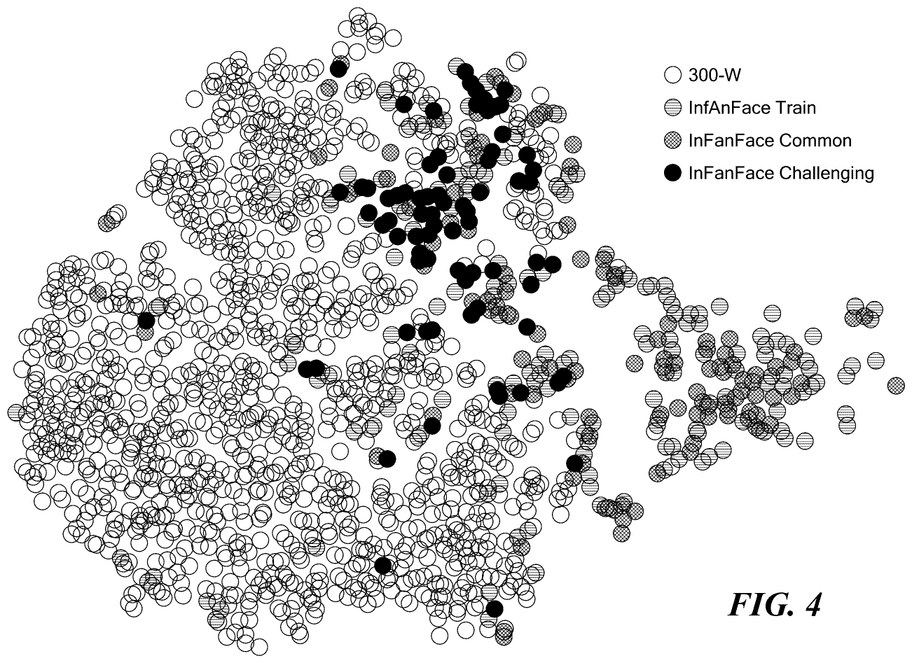

An elegant visual companion to the preceding analysis can be found in the t-distributed stochastic neighbor embedding (t-SNE) plots in FIG. 4, which offer a glimpse into the how the HRNet neural network “perceives” each image relative to one another. Each infant or adult image is processed by HRNet into a 270×64×64-dimensional vector (before the regression head), and the set of these representations is compressed by the t-SNE algorithm into a set of two-dimensional coordinates for each image, with relative relationships probabilistically preserved. This set of coordinates is plotted in FIG. 4, with image set membership highlighted by color. In line with other observations described herein, the t-SNE distribution highlights a general gap between adult and infant image sets, and within InfAnFace Test, a split between the tamer InfAnFace Common subset and the more divergent InfAnFace Challenging subset. InfAnFace Test as a whole is distributed similarly to InfAnFace Train.

Bridging the Infant-Adult Domain Gap

Further specialized efforts to solve facial landmark estimation for infant faces were required to bridge the infant-adult domain gap. In particular, the domain adaptation tools of joint-training and fine-tuning were applied, in addition to targeted data augmentation tools based on insights from the above-described analysis of the domain gap. The effectiveness of the resulting model is shown in FIG. 2. Quantitative analysis shows that, for instance, the modified HRNet model performs with a failure rate of 2.50% at NME_{iod}=10 on InfAnFace Test, drastically improving upon the 22.50% for the original HRNet model, and even approaching the 1.17% failure rate of the original HRNet on the adult 300-W Test set. Note that commonly used adversarial discriminative domain adaptation methods work well for classification but are typically ineffective in the regression domain adaptation setting, where the covariate shift assumption usually holds. Thus, it is believed that the present methods yield results competitive with what can be obtained from general domain adaptation tools applicable in the landmark estimation setting.

Training Implementations

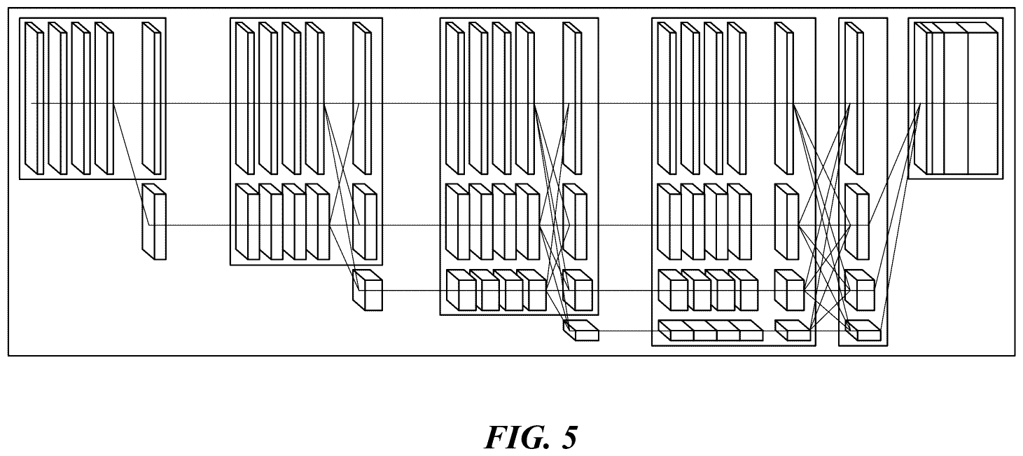

Initially, two existing models were used. One was a high-resolution net (HRNet) which, as shown in FIG. 5, runs multi-resolution convolutional layers connected in parallel. The other was a 3FabRec, which features an autoencoder ResNet structure that learns facial representations in an unsupervised manner before switching to supervised learning for facial landmark estimation.

For HRNet, extensive validation set experiments were performed (not involving the final test data) to test a number of joint-training and fine-tuning paradigms. Further, a range of training data augmentations were performed, including random zooms and rotations. The tests yielded two final models with similar validation performance:

HRNet-R90JT, HRNet jointly trained on the union of the 300-W training set and InfAnFace Train, with rotations of gap between adult and infant image sets, and within InfAnFace Test, a split between the tamer InfAnFace Common subset and the more divergent InfAnFace Challenging subset. InfAnFace Test as a whole is distributed similarly to InfAnFace Train.

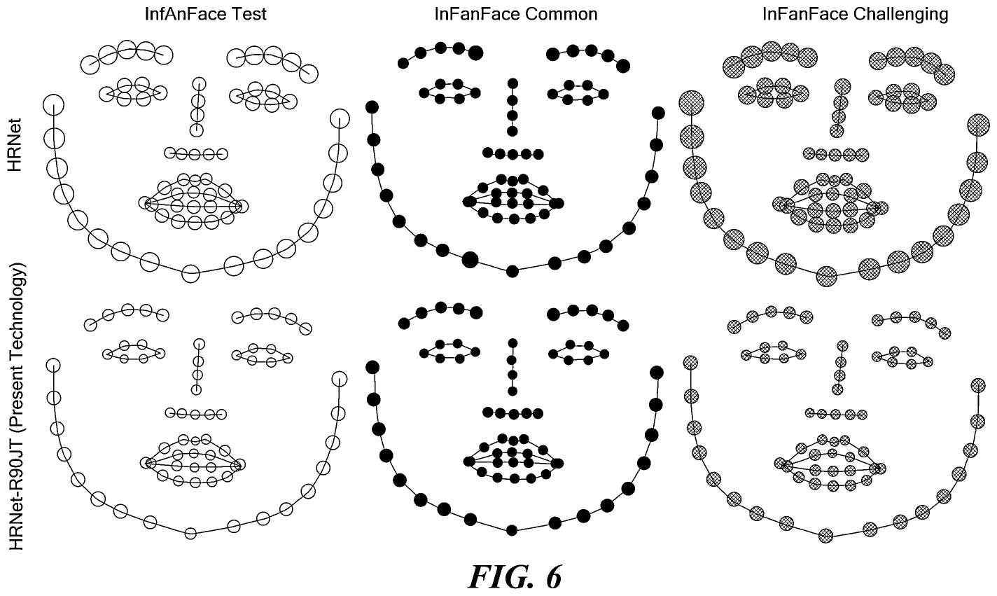

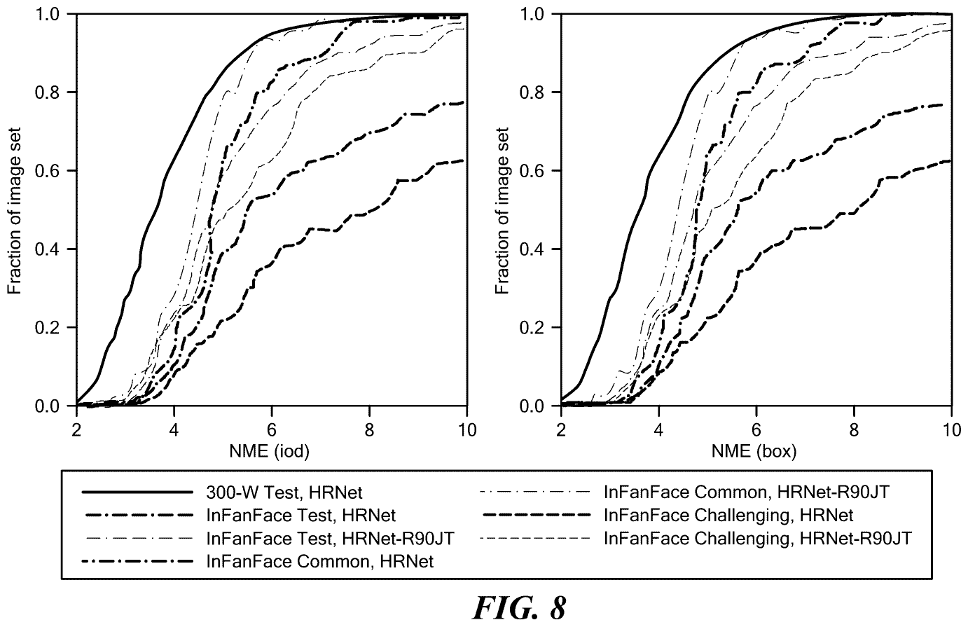

Additionally, HRNet-R90JT and HRNet were jointly trained on the union of the 300-W training set and InfAnFace Train, with rotations of models. These results are reported in Table III and Table IV, and sample landmark predictions for the best-performing HRNet-R90JT model can be found in FIG. 2. These results show significantly improved performance from HRNet-R90JT and HRNet-R90FT models compared to the original 3FabRec and HRNet, bringing infant facial landmark estimation results within striking range of the best results on adult faces. The most notable gains came from performance on InfAnFace Challenge, but there were also small gains in performance on InfAnFace Common. A visualization of the marked improvements of HRNet-R90JT over HRNet on a per-landmark level can be found in FIG. 6, and overall cumulative error curves can be found in FIG. 8.

The reported results on the models with ablated features, HRNet-JT, HRNet-FT, and HRNet-R90, demonstrate that both the infant training data and the wider rotation angles are needed to realize the full gains. Either feature, on its own, seems capable of taming the most egregious predictions on InfAnFace Challenge. The effect of applying wider rotation angles in training on models trained on infant data was shown to notably improve performance on InfAnFace Challenging faces at only a slight cost of performance on the largely upright faces in InfAnFace Common.

The performance of the modified 3FabRec models is weaker than that of correspondingly modified HR-Net models, perhaps in part due to the exhaustive hyperparameter validation tuning performed for the latter. However, the relative performances of the different 3FabRec variants support the conclusion that while domain adaptation and data augmentation are both individually quite effective for improving performance, their combination leads to further gains; and that most gains come from improvements to the difficult InfAnFace Challenging images.

Infant Face Detection

Facial landmark estimation models usually require information about face location as input, typically in the form of coordinates for a bounding box. These coordinates are included with test datasets like InfAnFace Test, but for most real-world applications, they need to be obtained beforehand from dedicated face detection models. While in principle, such models could be fine-tuned with infant data, they were found to be already adequate out-of-the-box.

To demonstrate this, a cutting-edge face detection model, RetinaFace, was applied to InfAnFace Test. For face detection, the main performance metric on a set of predictions is the average precision, defined as an interpolated area under an associated precision-recall curve. The average precisions of RetinaFace across the InfAnFace Test, Common, and Challenging sets respectively were 98.1%, 100.0%, and 94.7%, attesting to excellent performance on infants. Thus, the combination of RetinaFace and the present HRNet-R90FT and HRNet-R90JT models provide complete solutions to the facial landmark estimation task for infants.

In-Field Baby Monitor Challenge

Baby monitor footage of 15 real infant subjects was obtained under an Institutional Review Board approval. The videos featured infants napping and sleeping in their own crib or bassinet, typically under low-light conditions, triggering the baby monitor's monochromatic infrared capture mode. These pose and lighting conditions entail significant challenges to computerized comprehension.

213 private images from these videos were annotated in order to gauge facial landmark estimation performance in extremely adverse vision conditions. The predictions of the original HRNet on this set yielded respective NMEs of 32.3 and 15.5 under the minimal box size normalization, poor in comparison to the present HRNet-R90JT's error of 3.73 on the InfAnFace Challenging set.

Further data augmentation techniques were performed in an effort to mitigate this performance gap. A new model, HRNet-R150GJT, was developed, which was jointly trained on 300-W and InfAnFace Train data, with rotation augmentations in the range of ±150°, and a grayscale filter applied 1/2 of the time, where both hyperparameters were chosen based on validation on InfAnFace Train. The resulting predictions yielded an average NME of 11.7 under the box normalization factor.

Additional Features

Mean Adult and Infant Faces

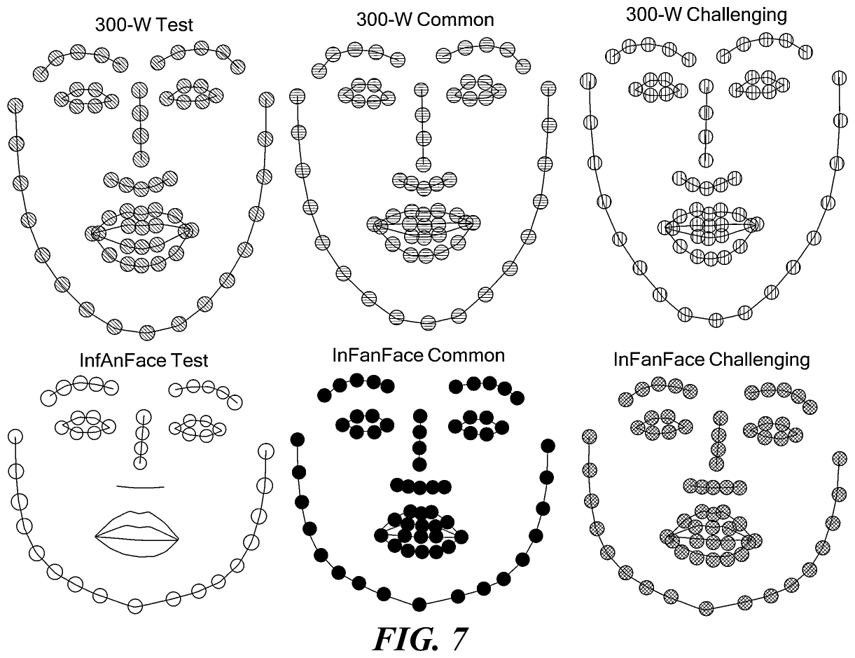

A broad view of differences between adult and infant facial landmark geometries is provided by FIG. 7, which shows the mean positions of ground truth landmarks within various 300-W and InfAnFace image sets. Mean positions reflect both intrinsic facial geometry and non-intrinsic facial pose (such as head orientation), so conclusions must be drawn cautiously. Still, adult faces certainly appear taller, with eyes set higher up the nose and jawlines more oblong. This corroborates the observations shown in Table II.

Cumulative Error Distribution Curves for Infant Landmark Estimation Models FIG. 8 displays the cumulative error distribution curves for both HRNet and best-performing new model, HRNet-R90JT. It shows performance gains across the board, but especially on the InfAnFace Challenging set, nearly eliminating the failure rate at NME_{iod}=10. The overall performance of HRNet-R90JT on InfAnFace Common even approaches the performance of HRNet on 300-W Test, a standard adult image set.

Definition of Average Precision for Facial Detection

The output of a facial detection model includes bounding boxes together with probabilistic confidence scores attached. For each 0<α<1, predictions with confidence scores greater than a are considered to be true positives if they overlap with a ground truth box with an area at least half that of their union, and as a result a precision and recall score can be computed for that a. By varying a, a precision-recall curve is generated, and the average precision is defined to be the interpolated area under that curve.

Tracking of Non-Nutritive Sucking (NNS)

NNS Background

Non-nutritive sucking (NNS) is defined as the sucking action that occurs when a finger, pacifier, or other object is placed in the baby's mouth, but there is no nutrient delivered. In addition to providing a sense of safety, NNS even can be regarded as an indicator of infant's central nervous system development. The rich data, such as sucking frequency, the number of cycles, and their amplitude during baby's non-nutritive sucking is important clue for judging the brain development of infants or preterm infants.

Non-nutritive sucking (NNS) is one of the earliest motor behaviors that occur after a baby is born. It refers to the sucking action that occurs when a finger, pacifier, or other object is placed in the baby's mouth, but there is no nutrient delivered, as opposed to nutritive sucking, which is the sequence that occurs when fluid is being introduced. Typical NNS pattern (bursts of suck and pause periods for respiration alternate) is characterized by 6-12 suck cycles per burst with an intra-burst frequency of around two suck cycles per second (,--2 Hz) for normal young infants (from 4 days to 6 months).

It is known that the NNS behavior is an effective way for infants to seek self-comfort. Moreover, it promotes the development of neonatal sucking response and regulate the secretion of gastrointestinal hormones. It even can be regarded as an indicator of the progress in the infant's central nervous system development. The rhythmical properties of NNS could be an objective clinical clue for judging the effects of congenital abnormalities and perinatal stress on the brain function of the young infant.

There is emerging evidence revealing that infant NNS and early feeding physiology is linked to oral feeding behaviors, childhood language, childhood motor abilities, IQ and overall neurodevelopment. Associations from these previous studies were in the same direction: better NNS is linked to higher scores and improved behaviors. Because the human infant is born with very few motor capabilities, NNS study is one of the assessments that can be done early in development that may be predictive of future neurodevelopment.

Currently, NNS data is typically collected by the use of contact devices such as pressure transducers. However; such invasive contact directly impacts the baby's natural sucking behavior, resulting in significant distortion in the collected data. For example, many researchers collect NNS data by inserting contact devices (e.g., special purpose pacifiers) inside the baby's mouth. Such pacifiers have embedded sensors such as pressure transducers. However, due to the high price of these measurement tools and the difficulty of operation for non-professionals, home-use of these devices has been hindered and they are limited to the lab/clinic use only. Moreover, such invasive contact will have a direct impact on the baby's natural sucking behavior, resulting in significant distortion in the collected data. Furthermore, the collected sensor data are often only analyzed by visual inspection and manual burst counting rather than using automatic analytical methods that can be robustly applied on large sets of sensor data to assure the objectivity of the results. In addition, when sensors are not available, clinicians often assess suck using a gloved finger, which is a highly subjective process.

The most commonly used NNS data acquisition device is a pacifier equipped with a pressure sensor. The pressure transducer is utilized for the measurement system to detect and measure the infants' NNS patterns during infant sucking pacifier. The pressure transducer is housed within the pacifier handle or in a separate boxed container. Such pressure transducer equipped pacifiers have been used to improve feeding development for premature and newborn infants by reinforcing NNS. The NNS evaluation session typically uses a specially designed system having pressure transducer coupled to a custom receiver with a sterile soothie silicone pacifier to measure the force generated by the lips, tongue and jaw during sucking behavior. However, this traditional NNS data collection method has some shortcomings. First, the high acquisition cost is not suitable for a wide range of applications. Second, contact-type acquisition may cause deformation in the infant's sucking pattern. The pacifier coupled with a pressure transducer will slightly displace the nipple making it slightly harder, causing a change in the feeling of sucking.

Additionally, there is another rarely used sucking pattern observation method: assessing infant's sucking pattern with non-invasive Neonatal Oral-Motor Assessment Scale (NOMAS) based on recorded feeding videos. The NOMAS demonstrates three sucking patterns: normal (or mature), disorganized, and dysfunctional sucking patterns. Jaw movements and some tongue movements are scored as observed from the video recordings, and the other tongue movements are scored indirectly from the movements of lips, cheeks and the base of the mouth, as described in the NOMAS manual. However, due to reliance on human practitioners to evaluate the video recordings and imperfect correlations between the indirect markers used for evaluation, such assessments are expensive, highly subjective, and somewhat unreliable.

Hence, there is a crucial need for a contact-less NNS data collection and analysis system, which is able to collect NNS signal in babies' natural settings, and extract parameters such as sucking cycles and their frequencies automatically.

Application of Infant Facial Estimation to NNS

A vision based NNS pattern quantification using advanced computer vision models can offer a valuable means in studying the relationship among sucking difficulties, oromotor delays and subsequent neurodevelopment in early life of an infant, which allows for timely diagnosis and treatment planning if needed. Through prior experimentation, the inventors have been able to qualitatively establish an association between facial landmark movement and NNS pattern. That method seeks to automatically extracts movements of the baby's jaw's landmark in a video by tracking the 2D facial landmarks and then fitting a 3D morphable model (3DMM) to generate 3D facial landmarks. However, the underlying insufficiency of previous facial estimation models with respect to infant facial estimation negatively impacted the accuracy of infant facial landmark tracking to the extent that results were too unreliable for quantitative study of the proportional relationship between amplitude of landmark movement and infant sucking intensity. By incorporation of the systems and methods for infant facial estimation provided herein, sufficiently objective and accurate extraction of NNS pattern parameters can be achieved without any external intrusion or interference from pacifiers and can be used to link infant sucking and feeding behaviors with subsequent speech-language production and cognition.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A method for identifying a face of an infant in an image, the method comprising the steps of:
providing a computer comprising a processor and a memory trained with a set of training images and programmed with a convolutional neural network (CNN) model for identifying a face of an infant in a test image suspected of comprising an infant's face, wherein each image of the set of training images includes a plurality of facial landmark annotations and at least one pose attribute annotation;
providing a test image suspected of comprising an image of an infant's face; and
processing the test image using the computer, whereby the infant's face is identified in the test image.

2. The method of claim 1, wherein the plurality of facial landmarks include at least interocular distance and minimal containment box.

3. The method of claim 1, wherein the plurality of facial landmark annotations adhere to a Multi-PIE layout.

4. The method of claim 1, wherein the at least one pose annotation includes a binary annotation indicating at least one of whether infant's face is turned, tilted, occluded, or excessively expressive.

5. The method of claim 1, wherein the step of processing the image further comprises identifying one or more of the plurality of facial landmarks of the identified infant's face in the test image.

6. The method of claim 5, wherein a series of test images are processed, the series of test images obtained from a video recording of an infant.

7. The method of claim 6, wherein the one or more facial landmarks are identified in each image of the series of test images, and wherein the one or more facial landmarks are tracked from image to image.

8. The method of claim 1, wherein the method is used in at least one of a method of identifying a behavior, identifying a developmental stage, diagnosing a developmental abnormality, or diagnosing a medical condition of an infant depicted in the test image.

9. The method of claim 8, wherein the behavior is non-nutritive sucking behavior.

10. The method of claim 1, wherein the method is used to identify an individual infant depicted in the test image.

11. The method of claim 1, further comprising jointly training the memory by rotating training between the set of training images and a second set of training images.

12. The method of claim 1, further comprising jointly training the memory by rotating training between the CNN model for identifying a face of an infant and a second CNN model for identifying a face of an infant.

13. The method of claim 1, wherein the CNN model includes at least one of HRNet, HRNetV2-W18, HRNet-R90JT, HRNet-R90FT, HRNet-R150GJT, 3FabRec, RetinaFace, or combinations thereof.

14. A method of producing a set of training images for training a convolutional neural network (CNN) model to identify a face of an infant in a test image, the method comprising the steps of:
providing a set of facial images of a plurality of different human infants; and
annotating each image of the set to define a plurality of facial landmarks; and
annotating each image of the set with at least one facial pose attribute.

15. The method of claim 14, wherein the plurality of facial landmarks include at least interocular distance and minimal containment box.

16. The method of claim 14, wherein the plurality of facial landmark annotations adhere to a Multi-PIE layout.

17. The method of claim 14, wherein the at least one pose annotation includes a binary annotation indicating at least one of whether infant's face is turned, tilted, occluded, or excessively expressive.

18. The method of claim 17, wherein the step of annotating each image of the set with at least one facial pose attribute further comprises at least one of:
applying a binary annotation indicating the infant's face is turned if at least one of the eyes, nose, and mouth are not clearly visible;
applying a binary annotation indicating the infant's face is tilted if the head axis, projected on the image plane, is 45° or more beyond upright;
applying a binary annotation indicating the infant's face is occluded if landmarks are covered by body parts or objects; or
applying a binary annotation indicating the infant's face is excessively expressive if the facial muscles are tense due to an exaggerated facial expression.

19. A system for identifying a face of an infant in an image, the system comprising a computer comprising:
a processor; and
a memory trained with a set of training images and programmed with a convolutional neural network (CNN) model for identifying a face of an infant in a test image suspected of comprising an infant's face, wherein the set of training images is obtained by the method of claim 14.

20. The system of claim 19, further comprising an imaging system in electronic communication with the computer, the imaging system configured to capture a series of test images of an infant and to provide the series of test images to the computer.
